(19) United States
(12) Patent Application Publication
(10) Pub. No.: US 2025/0130093 A1
(43) Pub. Date: Apr. 24, 2025

(54) TRANSPORT SYSTEM, TRANSPORT APPARATUS, TRANSPORT METHOD, AND STORAGE MEDIUM

(71) Applicant: NEC Corporation, Minato-ku, Tokyo (JP)

(72) Inventor: Taichi Kunagai, Tokyo (JP)

(73) Assignee: NEC Corporation, Minato-ku, Tokyo (JP)

(21) Appl. No.: 18/689,905

(22) PCT Filed: Sep. 14, 2021
(86) PCT No.: PCT/JP2021/033655

§ 371 Date: Mar. 7, 2024

(51) Int. Cl. G01G 19/414; G01G 19/52

(52) U.S. Cl. CPC G01G 19/414; G01G 19/52

(57) ABSTRACT

In order to estimate a weight of a transfer object in a wider variety of transfer embodiments, a transfer system (1) includes: an acquisition unit (11) for acquiring sensor information that changes in accordance with a distance between a transfer object and a transfer vehicle that is transferring the transfer object; and an estimation unit (12) for estimating the weight of the transfer object on the basis of time-series data of the sensor information.

### TECHNICAL FIELD

The present invention relates to a technique for estimating a weight of a transfer object.

### BACKGROUND ART

There is known a technique for estimating a weight of a transfer object. For example, Patent Literature 1 discloses a technique for estimating a weight of a transfer object on the basis of a detected value of an acceleration sensor mounted on a transfer vehicle and a weight of the transfer vehicle, at the time when the transfer vehicle tows the transfer object. Further, Patent Literature 2 discloses a transfer vehicle that moves a rear body which is loaded, said transfer vehicle changing a control constant of a motor on the basis of a speed to be reached at a time point at which a predetermined target period elapses.

### CITATION LIST

### Patent Literature

### [Patent Literature 1]

Japanese Patent Application Publication Tokukai No. 2020-032982

### [Patent Literature 2]

Japanese Patent Application Publication Tokukai No. 2020-149394

### SUMMARY OF INVENTION

### Technical Problem

The technique disclosed in Patent Literature 1 assumes a transfer embodiment in which the transfer vehicle tows the transfer object. Further, the technique disclosed in Patent Literature 2 assumes a transfer embodiment in which the transfer object is loaded on the transfer vehicle. In this way, these techniques have a problem in that assumed transfer embodiments are limited.

An example aspect of the present invention is attained in view of the above problem. An example object of the present invention is to provide a technique for estimating a weight of a transfer object in a wider variety of transfer embodiments.

### Solution to Problem

A transfer system according to an example aspect of the present invention including: an acquisition means for acquiring sensor information that changes in accordance with a distance between a transfer object and a transfer vehicle that is transferring the transfer object; and an estimation means for estimating a weight of the transfer object on the basis of time-series data of the sensor information.

A transfer apparatus according to an example aspect of the present invention including: an acquisition means for acquiring sensor information that changes in accordance with a distance between a transfer object and a transfer vehicle that is transferring the transfer object; and an estimation means for estimating a weight of the transfer object on the basis of time-series data of the sensor information.

A transfer method according to an example aspect of the present invention including: acquiring sensor information that changes in accordance with a distance between a transfer object and a transfer vehicle that is transferring the transfer object; and estimating a weight of the transfer object on the basis of time-series data of the sensor information.

### Advantageous Effects of Invention

An example aspect of the present invention makes it possible to estimate a weight of a transfer object in a wider variety of transfer embodiments.

### BRIEF DESCRIPTION OF DRAWINGS

FIG. 1 is a block diagram illustrating a configuration of a transfer system according to a first example embodiment of the present invention.

FIG. 2 is a flow chart illustrating a flow of a transfer method according to the first example embodiment of the present invention.

FIG. 3 is a diagram schematically illustrating an example of a transfer embodiment of the transfer system according to the first example embodiment of the present invention.

FIG. 4 is a diagram schematically illustrating an example of a transfer embodiment of the transfer system according to the first example embodiment of the present invention.

FIG. 5 is a diagram schematically illustrating an example of a transfer embodiment of the transfer system according to the first example embodiment of the present invention.

FIG. 6 is a block diagram illustrating an example of an apparatus configuration that realizes the first example embodiment of the present invention.

FIG. 7 is a block diagram illustrating an example of an apparatus configuration that realizes the first example embodiment of the present invention.

FIG. 8 is a block diagram illustrating an example of an apparatus configuration that realizes the first example embodiment of the present invention.

FIG. 9 is a diagram schematically illustrating a transfer embodiment of a transfer system according to a second example embodiment of the present invention.

FIG. 10 is a block diagram illustrating a configuration of the transfer system according to the second example embodiment of the present invention.

FIG. 11 is a bottom view of the transfer vehicle according to the second example embodiment of the present invention.

FIG. 12 is a graph showing an example of time-series data of sensor information according to the second example embodiment of the present invention.

FIG. 13 is a flow chart illustrating a flow of a transfer method according to the second example embodiment of the present invention.

FIG. 14 is a diagram schematically illustrating a transfer embodiment of a transfer system according to a third example embodiment of the present invention.

FIG. 15 is a block diagram illustrating a configuration of the transfer system according to the third example embodiment of the present invention.

FIG. 16 is a flow chart illustrating a flow of a transfer method according to the third example embodiment of the present invention.

FIG. 17 is a block diagram illustrating a configuration of a computer that functions as a transfer vehicle, a first transfer vehicle, a second transfer vehicle, or a management apparatus according to the first to third example embodiments of the present invention.

### DESCRIPTION OF EMBODIMENTS

[First example embodiment]

A first example embodiment of the present invention will be described in detail with reference to the drawings. The present example embodiment is a basic form of example embodiments described later.

### <Configuration of Transfer System>

The following description will discuss a configuration of a transfer system 1 according to the present example embodiment, with reference to FIG. 1. FIG. 1 is a block diagram illustrating a configuration of the transfer system 1. The transfer system 1 is a system that estimates a weight of a transfer object which is transferred by a transfer vehicle. The transfer system 1 includes an acquisition unit 11 and an estimation unit 12. The acquisition unit 11 is configured to realize an acquisition means in the present example embodiment. The estimation unit 12 is configured to realize an estimation means in the present example embodiment.

The acquisition unit 11 acquires sensor information that changes in accordance with a distance between a transfer object and a transfer vehicle which is transferring the transfer object. The estimation unit 12 estimates the weight of the transfer object on the basis of time-series data of the sensor information.

### (Transfer Object)

The transfer object is an object which is transferred by the transfer vehicle. The transfer object is, for example, a cart for transfer in which wheels are attached to a lattice-shaped structure (basket), that is, a so-called basket car (roll box pallet). The transfer object is not limited to a basket car, but may be, for example, a cart, a container, or a trailer for carrying a load or passenger other than the basket car.

### (Transfer Vehicle)

A transfer vehicle is a transfer apparatus that transfers a transfer object. In one example, the transfer vehicle is an automated guided vehicle (AGV) that travels autonomously. Further, the transfer vehicle may be a vehicle that is operated by a person so as to travel. Examples of the transfer vehicle include a moving mechanism for transferring a transfer object and a drive mechanism for driving the moving mechanism. The moving mechanism is, for example, a wheel, a caterpillar tread or a propeller. The drive mechanism is, for example, a motor for rotationally driving a wheel.

The transfer vehicle e transfers a transfer object by applying force directly or indirectly to the transfer object. In one example, the transfer vehicle transfers a transfer object by applying force that pushes the transfer object in a traveling direction. Alternatively, the transfer vehicle may be a towing vehicle that transfers, by towing, the transfer object. The transfer vehicle may apply force to the transfer object via an elastic member which has elasticity or via another member. When the transfer vehicle applies force to the transfer object, the transfer vehicle and the transfer object move while a distance between the transfer vehicle and the transfer object varies. The transfer vehicle and the transfer object may be coupled to each other by a coupling member or the like, or alternatively, may not be coupled to each other.

Further, the transfer vehicle may include a first transfer vehicle and a second transfer vehicle that transfers the transfer object in cooperation with the first transfer vehicle. In this case, in one example, the first transfer vehicle may transfer the transfer object by pushing the transfer object from behind the transfer object in the traveling direction, and the second transfer vehicle may travel ahead of the transfer vehicle at a speed which is the same or substantially the same as the speed of the first transfer vehicle, and the transfer object may be transferred in a state in which the first transfer vehicle and the second transfer vehicle sandwich the transfer object.

### (Sensor Information)

The sensor information is a detected value of the sensor or information that is specified on the basis of a detected value of the sensor, and is information that changes in accordance with the distance between the transfer vehicle and the transfer object during transfer. In one example, the sensor information is information that indicates the distance between the transfer vehicle and the transfer object. The distance is detected by a ranging sensor that is provided in the transfer vehicle. Alternatively, in one example, the sensor information may be information that indicates an elastic force calculated on the basis of a spring length (the distance between the transfer vehicle and the transfer object measured by the ranging sensor) of the elastic member disposed between the transfer vehicle and the transfer object, that is, a magnitude of a stress applied to the transfer object via the elastic object. The distance between the transfer vehicle and the transfer object is, for example, a distance from a position of the ranging sensor provided in the transfer vehicle to a surface of the transfer object.

### <Flow of Transfer Method>

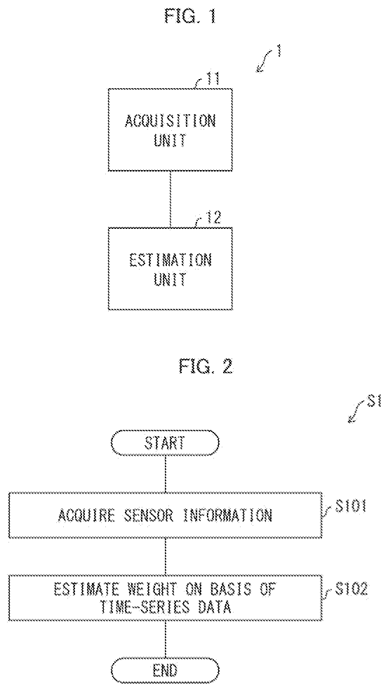

FIG. 2 is a flow chart illustrating a flow of a transfer method S1 according to the first example embodiment of the present invention. The transfer method S1 includes step S101 and step S102.

### (Step S101)

Step S101 is the step of acquiring sensor information that changes in accordance with a distance between a transfer object and a transfer vehicle which is transferring the transfer object. In one example, the acquisition unit 11 acquires the sensor information that indicates a detected value of a ranging sensor which measures the distance between the transfer vehicle and the transfer object. The acquisition unit 11 may acquire, as the sensor information, information that indicates a stress applied to the transfer object, which is calculated on the basis of the detected value of the ranging sensor.

### (Step S102)

Step S102 is the step of estimating the weight of the transfer object on the basis of time-series data of the sensor information acquired in step S101. In one example, the estimation unit 12 extracts a variation pattern of the distance on the basis of the time-series data of the sensor information and estimates the weight on the basis of the variation pattern thus extracted. The variation pattern includes, for example, (i) an analysis result obtained by difference conversion of the time-series data and/or (ii) an analysis result in a frequency domain of the time-series data. In other words, the estimation unit 12 extracts, as the variation pattern, (i) the analysis result obtained by difference conversion of the time-series data and/or (ii) the analysis result in the frequency domain of the time-series data.

The time-series data used by the estimation unit 12 for estimation of the weight is time-series data in a period during which the transfer vehicle is transferring the transfer object. The time-series data is, for example, time-series data which is obtained in a period from when the transfer vehicle starts to transfer the transfer object until when a first condition is satisfied. In other words, the estimation unit 12 may estimate the weight on the basis of the time-series data which is obtained in a period from when the transfer vehicle starts to transfer the transfer object until when the first condition is satisfied. The first condition includes, for example, the following condition: a predetermined period has elapsed; or a variation width of the time-series data converges within a predetermined threshold value.

As a method by which the estimation unit 12 estimates the weight, it is possible to use a machine learning method or a rule-based method. In other words, the estimation unit 12 may estimate the weight with use of an estimation model that is generated by machine learning or may estimate the weight on the basis of a rule.

### (Case of Estimation Using Estimation Model)

In a case where the estimation unit 12 uses an estimation model, the estimation model is, for example, an estimation model which outputs the weight by using, as an input, the time-series data of the sensor information or a feature of the time-series data. A method of machine learning of the estimation model is not limited. For example, it is possible to use a decision tree-based method, a method using linear regression, or a method using a neural network, or use two or more of these methods. The decision-tree based method includes, for example, methods using Light Gradient Boosting Machine (LightGBM), random forest, and XGBoost. The linear regression includes, for example, support vector regression, Ridge regression, Lasso regression, and ElasticNet. Examples of the neural network include deep learning.

In this case, the input data of the estimation model is the time-series data of the sensor information or a feature of the time-series data. The feature of the time-series data is a feature that is obtained by analyzing the time-series data, and is, for example, a variation pattern of the distance between the transfer object and the transfer vehicle. Examples of the variation pattern include a characteristic of starting movement (acceleration) that is obtained by difference conversion, a frequency characteristic that is obtained by frequency domain analysis, or a periodicity of movement that is obtained by an autocorrelation function, an approximate entropy method, or the like. The characteristic of the starting movement (acceleration) that is obtained by the difference conversion is, for example, an average value or dispersion of differences that are obtained by the difference conversion. The frequency domain analysis is performed by, for example, a Fourier transform, a wavelet transform, or a welch method. The autocorrelation function is calculated by, for example, an arbitrary lag or an arbitrary AR model.

### (Case of Estimation Based on Rule)

On the other hand, in a case where the estimation unit 12 estimates the weight on the basis of a rule, the estimation unit 12 estimates the weight, for example, by referring to a table that stores a corresponding relationship between (i) the time-series data or the feature of the time-series data and (ii) the weight of the transfer object, and identifying the weight corresponding to the sensor information acquired by the acquisition unit 11. More specifically, the estimation unit 12 may, for example, compare a variation pattern that is registered in a database with the variation pattern that is extracted from the sensor information acquired by the acquisition unit 11 and identify the weight that is associated with the variation pattern similar to the variation pattern extracted from the sensor information. Further, for example, the estimation unit 12 may specify the weight that is associated with the feature similar to the feature of the sensor information by comparing the feature of the time-series data that is registered in the database with the feature of the sensor information acquired by the acquisition unit 11.

### Transfer Embodiment 1

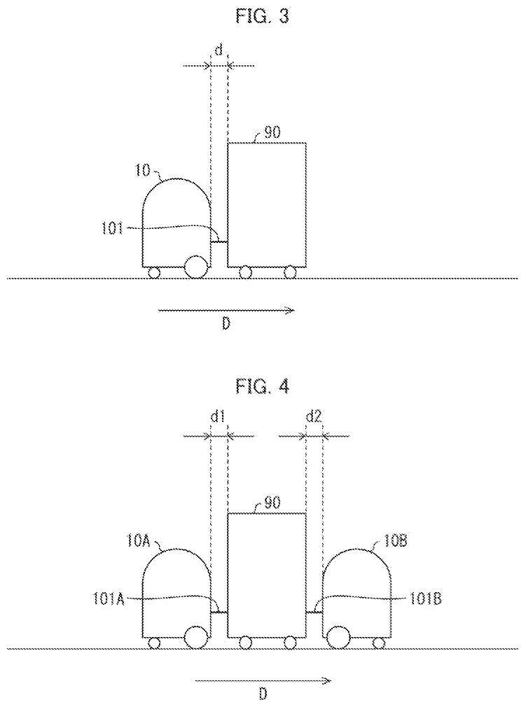

FIG. 3 is a diagram schematically illustrating an example of a transfer embodiment of the transfer system 1. In the example of FIG. 3, the transfer vehicle 10 includes a coupling part 101. The transfer vehicle 10 and the transfer object 90 may be coupled to each other by the coupling part 101, or may not be coupled to each other. The coupling part 101 includes a member, such as a spring, a string, or a chain, that makes the distance d between the transfer vehicle 10 and the transfer object 90 variable. When the transfer vehicle 10 moves in a direction of an arrow D, force is applied by the transfer vehicle to the transfer object 90 directly or via the coupling part 101, and the transfer object 90 moves in the direction of the arrow D. During the transfer, the distance d varies with time. Particularly, the distance d varies to a larger extent over a period from when the transfer object 90 starts to move until when the speed is stabilized (period of acceleration).

### Transfer Embodiment 2

FIG. 4 is a diagram schematically illustrating another example of a transfer embodiment of the transfer system 1. In the example of FIG. 4, the transfer vehicle includes a first transfer vehicle 10A and a second transfer vehicle 10B. The first transfer vehicle 10A transfers the transfer object 90 in the direction of an arrow D by applying force to the transfer object 90 in the direction of the arrow D. The second transfer vehicle 10B transfers the transfer object 90 in cooperation with the first transfer vehicle 10A. In this example, the first transfer vehicle 10A is disposed behind the transfer object 90 in the transfer direction. The second transfer vehicle 10B is disposed ahead of the transfer object 90. The transfer object 90 is transferred by moving the first transfer vehicle 10A and the second transfer vehicle 10B at respective speeds that are the same or substantially the same each other in a state in which the transfer object 90 is sandwiched between the first transfer vehicle 10A and the second transfer vehicle 10B.

The first transfer vehicle 10A includes a coupling part 101A, and the second transfer vehicle 10B includes a coupling part 101B. The first transfer vehicle 10A and the transfer object 90 may be coupled to each other by the coupling part 101A, or may not be coupled to each other. Further, the second transfer vehicle 10B and the transfer object 90 may be coupled to each other by the coupling part 101B, or may not be coupled to each other. The coupling parts 101A and 101B have the same configuration as the coupling part 101.

When the first transfer vehicle 10A moves in the direction of the arrow D, force is applied by the first transfer vehicle 10A to the transfer object 90 directly or via the coupling part 101A, and the transfer object 90 moves in the direction of the arrow D. During the transfer, a distance d1 between the first transfer vehicle 10A and the transfer object 90 and a distance d2 between the second transfer vehicle 10B and the transfer object 90 vary with time. The distance d1 and the distance d2 in particular vary to a larger extent over a period from when the transfer object 90 starts to move until when the speeds are stabilized.

### Transfer Embodiment 3

FIG. 5 is a diagram schematically illustrating another example of a transfer embodiment of the transfer system 1. In the example of FIG. 5, the transfer vehicle 10 tows and transfers the transfer object 90 in a direction of an arrow D. The transfer vehicle 10 and the transfer object 90 may be coupled to each other by the coupling part 101.

When the transfer vehicle 10 moves in the direction of the arrow D, force is applied by the transfer vehicle 10 to the transfer object 90 via the coupling part 101, and the transfer object 90 moves in the direction of the arrow D. During transfer, a distance d between the transfer vehicle 10 and the transfer object 90 varies with time. The distance d in particular varies to a larger extent over a period from when the transfer object 90 starts to move until when the speed is stabilized.

### Example 1 of Apparatus Configuration

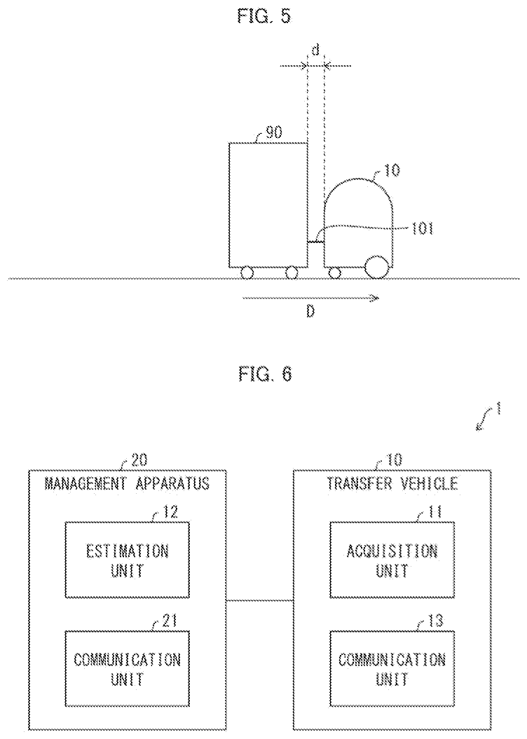

FIG. 6 is a block diagram illustrating an example of an apparatus configuration that realizes the transfer system 1. In the example of FIG. 6, the transfer system 1 includes the transfer vehicle 10 and a management apparatus 20. The transfer vehicle 10 includes the acquisition unit 11 and a communication unit 13. The management apparatus 20 includes an estimation unit 12 and a communication unit 21. In other words, the transfer vehicle 10 includes at least the acquisition unit 11, and the management apparatus 20 includes at least the estimation unit 12. The communication unit 13 transmits and receives information to and from the management apparatus 20 via a communication line. The communication unit 21 transmits and receives information to and from the transfer vehicle 10 via a communication line. Examples of the communication line include a radio communication line of Wi-Fi (registered trademark), long term evolution (LTE), 5G, local 5G, 4G, 3G, or the like or a wired communication line. The transfer vehicle 10 transmits, to the management apparatus 20 via the communication unit 21, the sensor information acquired by the acquisition unit 11. The management apparatus 20 receives the sensor information via the communication unit 21, and the estimation unit 12 estimates the weight of the transfer object on the basis of the time-series data of the sensor information received.

### Example 2 of Apparatus Configuration

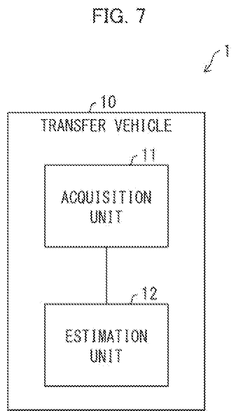

FIG. 7 is a block diagram illustrating another example of an apparatus configuration that realizes the transfer system 1. In the example of FIG. 7, the transfer system 1 includes the transfer vehicle 10. The transfer vehicle 10 includes at least the acquisition unit 11 and the estimation unit 12. The transfer vehicle 10 is an example of the transfer apparatus according to the present specification.

### Example 3 of Apparatus Configuration

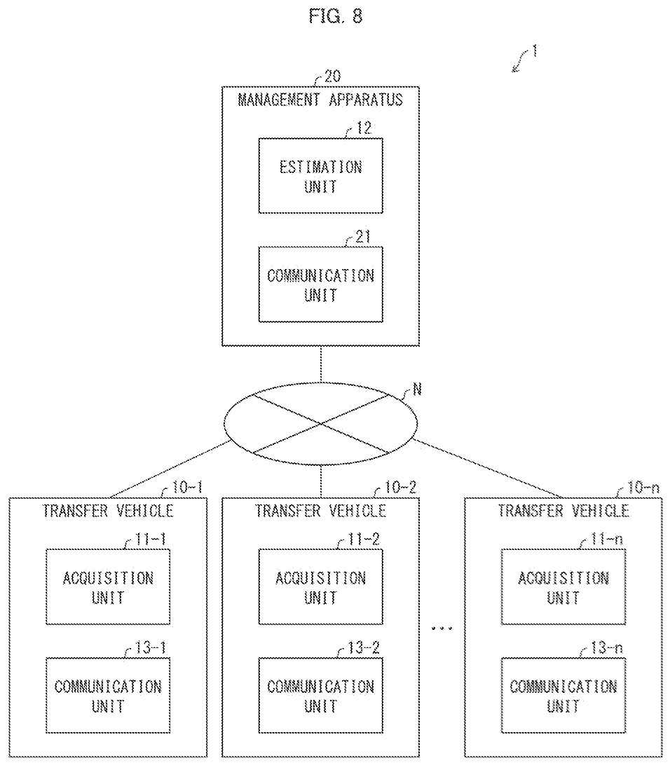

FIG. 8 is a block diagram illustrating another example of an apparatus configuration that realizes the transfer system 1. In the example of FIG. 8, the transfer system 1 includes a plurality of the transfer vehicles 10-1, 10-2, . . . , 10-n (where n is an integer of 2 or more) and the management apparatus 20. The transfer vehicle 10-i (1<i≤n) includes an acquisition unit 11-i and a communication unit 13-i. The management apparatus 20 includes the estimation unit 12 and the communication unit 21. In other words, the transfer vehicle 10-i (1<i≤n) includes at least the acquisition unit 11-i, and the management apparatus 20 includes at least the estimation unit 12. A single transfer vehicle 10-i alone may transfer a transfer object, or a plurality of transfer vehicles 10-i may transfer a transfer object in cooperation with each other. In a case in which the plurality of transfer vehicles 10-i transfer a transfer object in cooperation with each other, the management apparatus 20 may estimate the weight of the transfer object, for example, on the basis of the sensor information which is acquired by the transfer vehicle 10-i that travels ahead of the transfer object. Alternatively, the management apparatus 20 may estimate the weight of the transfer object on the basis of the sensor information which is acquired by the transfer vehicle 10-i that travels behind the transfer object. Alternatively, the management apparatus 20 may estimate the weight of the transfer object in consideration of both of the sensor information which is acquired by the transfer vehicle 10-i traveling ahead of the transfer object and the sensor information which is acquired by the transfer vehicle 10-i traveling behind the transfer object.

Each of functional units of the transfer system 1 may be included in one apparatus, as illustrated in FIGS. 6 to 8, or may not be included in one apparatus. For example, the acquisition unit 11 and the estimation unit 12 may be included in one apparatus, or the acquisition unit 11 and the estimation unit 12 may be configured to be mounted on respective separate apparatuses.

As described above, the transfer system 1 according to the present example embodiment employs a configuration in which: sensor information that changes in accordance with a distance between a transfer object and a transfer vehicle which is transferring the transfer object is acquired; and then, the weight of the transfer object is estimated on the basis of time-series data of the sensor information. Therefore, the transfer system 1 according to the present example embodiment has an example advantage of being capable of estimating the weight of the transfer object in a wider variety of transfer embodiments.

### Second Example Embodiment

The following description will discuss a second example embodiment of the present invention, with reference to the drawings. Note that members having functions identical to those of the respective members described in the first example embodiment are given respective identical reference numerals, and descriptions of those members will be omitted as appropriate.

### Transfer Embodiment of Transfer System

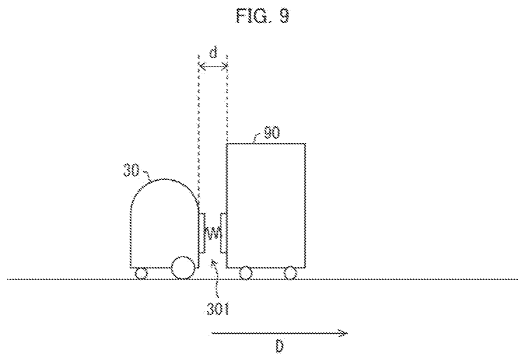

FIG. 9 is a diagram schematically illustrating a transfer embodiment of a transfer system 2 in accordance with the second example embodiment. The transfer vehicle 30 is an automated guided vehicle that travels autonomously, and transfers a transfer object 90 in a direction of an arrow D. The transfer vehicle 30 includes a coupling part 301. The coupling part 301 is constituted by two plates and an elastic body sandwiched between the two plates. The transfer object 90 and the coupling part unit 301 may be connected to each other, or may not be connected to each other.

When the transfer vehicle 30 moves in the direction of the arrow D, force is applied by the transfer vehicle 30 to the transfer object 90 via the coupling part 301, and the transfer object 90 moves in the direction of the arrow D. In FIG. 9, a distance d between the transfer vehicle 30 and the transfer object 90 is a distance from an anterior end part of the transfer vehicle 30 that does not include the coupling part 301 to the transfer object 90 in the direction of the arrow D. Since the coupling part 301 includes the elastic body, the distance d between the transfer vehicle 30 and the transfer object 90 varies with time during transfer of the transfer object 90. The distance d particularly varies to a larger extent over a period from when the transfer object 90 starts to move until when the speed is stabilized.

### <Configuration of Transfer System>

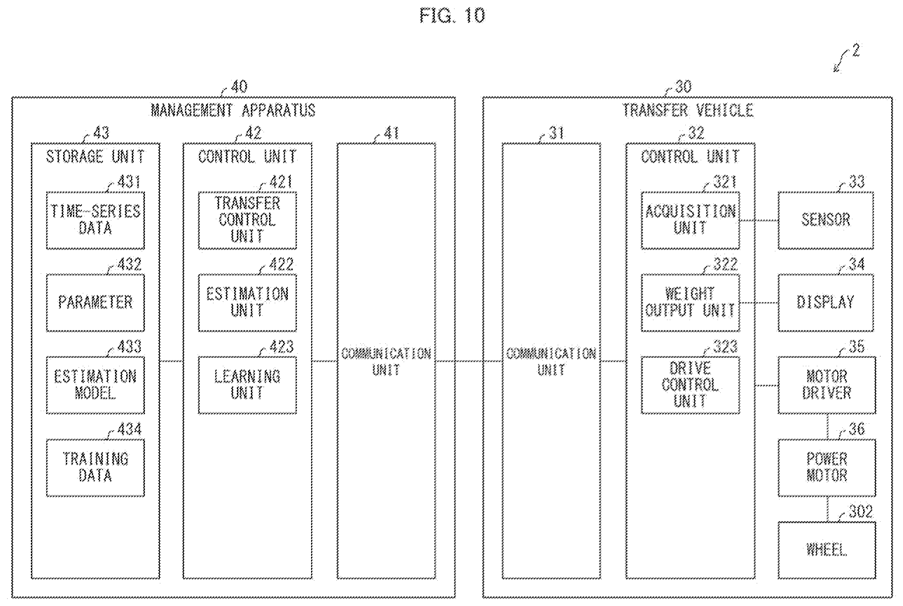

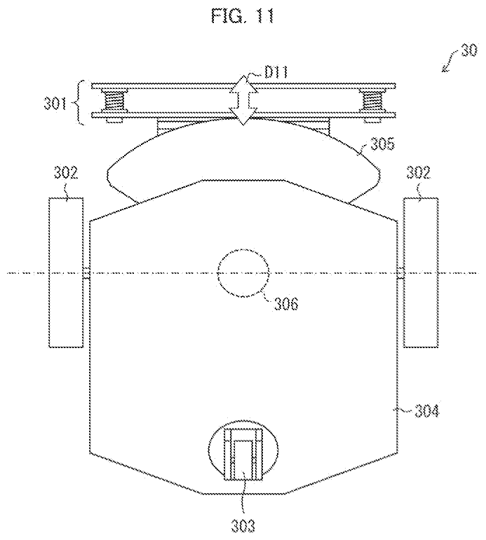

FIG. 10 is a block diagram illustrating a configuration of the transfer system 2. In the example of FIG. 10, the transfer system 2 includes the transfer vehicle 30 and a management apparatus 40.

### (Configuration of the Transfer Vehicle)

The transfer vehicle 30 autonomously travels on the basis of control information that is supplied by the management apparatus 40, and transfers the transfer object 90. The transfer vehicle 30 includes a communication unit 31, a control unit 32, a sensor 33, a display 34, a motor driver 35, a power motor 36, and wheels 302. The communication unit 31 transmits and receives information to and from the management apparatus 40 via a communication line, under control of the control unit 32. Hereinafter, transmitting and receiving information by the control unit 32 to and from the management apparatus 40 via the communication unit 31 is also described simply as transmitting and receiving information by the control unit 32 to and from the management apparatus 40.

The control unit 32 includes an acquisition unit 321, a weight output unit 322, and a drive control unit 323. The acquisition unit 321 is an example of an acquisition means described in claims. The acquisition unit 321 acquires, from the sensor 33, sensor information that indicates the distance between the transfer object 90 and the transfer vehicle 30. The acquisition unit 321 transmits, to the management apparatus 40, the sensor information thus acquired.

The weight output unit 322 outputs, to an output apparatus, the weight estimated by the estimation unit 422. In one example, the weight output unit 322 outputs, to the display 34, information that indicates the weight. Note that an output destination of the information that indicates the weight is not limited to a display. The weight output unit 322 may output the weight to another output apparatus such as a speaker or a printing apparatus, or may transmit the information that indicates the weight to another apparatus via the communication unit 31.

The sensor 33 is a ranging sensor that measures the distance between the transfer object 90 and the transfer vehicle 30. The sensor 33 is, for example, a linear displacement sensor, a time-of-flight (ToF) sensor, a Doppler sensor, or a camera. In one example, the sensor 33 is provided at an anterior end part of the transfer vehicle 30 which does not include the coupling part 301 in the direction of the arrow D in FIG. 9. The display 34 displays various kinds of information under the control of the control unit 32.

The drive control unit 323 controls the motor driver 35 in accordance with the control information received from the management apparatus 40. The motor driver 35 controls drive of the power motor 36 under the control of the control unit 32. The power motor 36 rotationally drives the wheel 302, so that the transfer vehicle 30 autonomously travels. The wheel 302 supports a main body part 304 and is driven by the power motor 36, so as to cause the transfer vehicle 30 to move forward and backward and to rotate.

### (Configuration of Management Apparatus)

The management apparatus 40 supplies the control information to the transfer vehicle 30 and controls autonomous travelling of the transfer vehicle 30. The management apparatus 40 includes a communication unit 41, a control unit 42, and a storage unit 43. The communication unit 41 transmits and receives information to and from the transfer vehicle 30 via a communication line, under control of the control unit 42. Hereinafter, transmitting and receiving information by the control unit 42 to and from the transfer vehicle 30 via the communication unit 41 is also described simply as transmitting and receiving information by the control unit 42 to and from the transfer vehicle 30.

The control unit 42 includes a transfer control unit 421, an estimation unit 422, and a learning unit 423. The transfer control unit 421 supplies the control information to the transfer vehicle 30. The control information is information that is supplied to the transfer vehicle 30 in order to control the autonomous travelling of the transfer vehicle 30. Examples of the control information include: a parameter 432 which will be described later; or information that is specified on the basis of the parameter 432. The parameter 432 is a control parameter for controlling transfer carried out by the transfer vehicle 30.

In one example, the parameter 432 includes a parameter(s) that indicates (i) a target value of the distance d, (ii) a movement speed of the transfer vehicle 30, (iii) acceleration/deceleration of the transfer vehicle 30, and/or (iv) timing of deceleration/stop of the transfer vehicle 30. More specifically, examples of the parameter(s) 432 include a maximum travel speed, a restriction on the acceleration/deceleration (steepness), and/or a distance to a goal or obstacle at which deceleration is to be started.

In one example, the transfer control unit 421 supplies the transfer vehicle 30 with control information that causes the distance d to approach the target value during transfer carried out by the transfer vehicle 30. The control unit 32 controls drive of the power motor 36 via the motor driver 35 on the basis of the control information that has been supplied, and causes the transfer vehicle 30 to autonomously travel.

The estimation unit 422 estimates the weight of the transfer object 90 by using (i) time-series data of the sensor information outputted by the transfer vehicle 30 and (ii) an estimation model 433 that estimates the weight of the transfer object 90. More specifically, the estimation unit 422 estimates the weight by extracting a feature from the time-series data and inputting, to the estimation model 433, the feature thus extracted. In one example, the feature of the time-series data includes (i) an analysis result obtained by difference conversion of the time-series data or (ii) an analysis result in frequency domain of the time-series data.

The learning unit 423 generates the estimation model 433 by machine learning with use of a training data 434. The estimation model 433 is a trained model which has undergone machine learning so as to output the weight of the transfer object 90 by using, as an input, the feature of the time-series data of the sensor information. The training data 434 is used when the learning unit 423 constructs the estimation model 433. The training data 434 is, for example, a set of first data and second data. The first data indicates an extraction result of the feature of the time-series data of the sensor information at the time when the transfer vehicle 30 actually transfers the transfer object 90. The second data indicates the weight of the transfer object 90. A method of machine learning of the estimation model 433 is not limited. For example, it is possible to use a decision tree-based method, a method using linear regression, or a method using a neural network, or use two or more of these methods.

A method of inputting the training data 434 is not limited. In one example, a manager may input the set of the first data and the second data to the management apparatus 40, or alternatively a predetermined system may gather information from each place and input, to the management apparatus 40, the information altogether. In this case, for example, training data which has been collected in a predetermined period (e.g., three hours, one day, or three days) may be collectively inputted to the management apparatus 40. Further, the first data and second data may be inputted at the same input timing or at different input timings. For example, the first data may be collected in real time, and the manager may later input, to the management apparatus 40, the weight (second data) of the transfer object corresponding to the time at which the data was collected. Further, for example, the management apparatus 40 may communicate with an apparatus such as a scale and receive an input of the second data.

The storage unit 43 stores time-series data 431, the parameter 432, the estimation model 433, and the training data 434. The time-series data 431 is sensor information acquired by the acquisition unit 321, that is, time-series data of the distance d.

Each functional unit of the transfer vehicle 30 and the management apparatus 40 may be included in one apparatus or may not be included in one apparatus. For example, the storage unit 43 of the management apparatus 40 may be provided in a cloud server, and the management apparatus 40 may communicate with the storage unit 43 via a communication line. Further, for example, some of functional units of the transfer vehicle 30 may be provided in the management apparatus 40 or in another apparatus. Further, some of functional units of the management apparatus 40 may be provided in the transfer vehicle 30 or another apparatus. For example, it is it possible to have a configuration in which the estimation unit 422 is mounted on the transfer vehicle 30 and an estimation result of the estimation unit 422 is transmitted to the management apparatus 40. Further, for example, it is possible to have a configuration in which the weight output unit 322 is mounted on the management apparatus 40 and the weight output unit 322 transmits the estimation result of the estimation unit 422 to another transmission through the communication unit 41.

FIG. 11 is a bottom view of the transfer vehicle 30. The transfer vehicle 30 includes the coupling part 301, a plurality of the wheels 302, a caster 303, the main body part 304, and a rotating part 305. The coupling part 301 is fixed to the rotating part 305. The wheels 302 constitute a moving mechanism for moving the transfer vehicle 30, and the transfer vehicle 30 is moved by rotation of the wheels 302. The caster 303 rotates as the transfer vehicle 30 moves. The rotating part 305 rotates in a predetermined range around a rotation shaft 306 which is an axis and which is provided in the main body part 304. The rotating part 305 rotates under the control of the control unit 32. Rotation of the connecting part 301 changes a movement direction of the transfer object 90 which is in contact with the coupling part 301. Further, the coupling part 301 expands/contracts in a direction indicated by an arrow D11 due to expansion/contraction of the elastic body during transfer of the transfer object 90, and the distance d between the transfer vehicle 30 and the transfer object 90 also extends/shrinks in accordance with the expansion/contraction of the coupling unit 301.

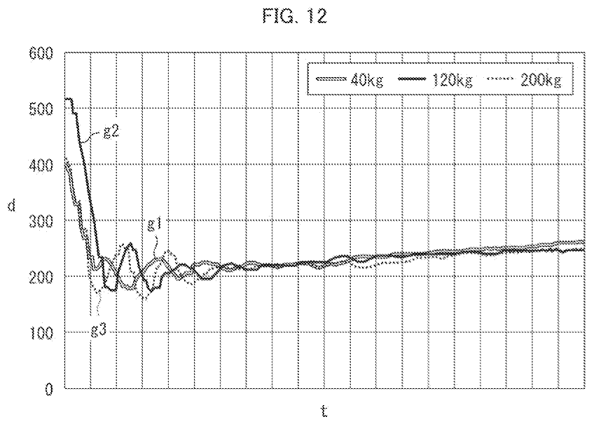

FIG. 12 is a graph illustrating an example of time-series data of center information. Graphs g1 to g3 represent pieces of time-series data of respective distances detected by the sensor 33 in a case where the transfer vehicle 30 transfers transfer objects 90 having respective weights of “40 kg”, “120 kg”, and “200 kg”. In FIG. 12, the horizontal axis represents time, and the vertical axis represents the distance d. As illustrated in FIG. 12, the distance d greatly varies in a period from when the transfer vehicle 30 starts to move until when the transfer speed stabilizes. On the other hand, when a certain period of time elapses after the start of transfer, movement of the transfer object 90 becomes smooth and the movement speed is stabilized, so that variation of the distance d becomes smaller. Further, as illustrated in FIG. 12, when the weight of the transfer object 90 is larger, a longer time elapses before the distance d is stabilized, and when the weight is larger, the period of oscillation of the distance d is longer. In this way, the variation pattern of the distance indicated by the time-series data differs according to the weight of the transfer object 90.

### <Flow of Transfer Method>

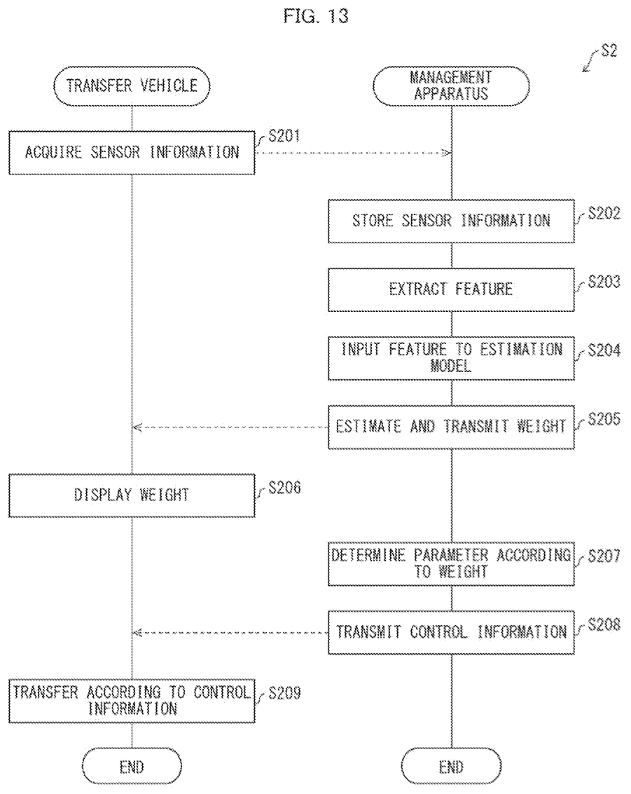

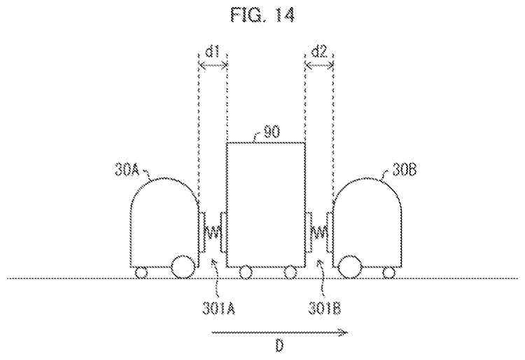

FIG. 13 is a flow chart illustrating a flow of a transfer method S2 according to the present example embodiment. The transfer method S2 includes steps S201 to S209. The transfer method S2 is started at the time when the transfer vehicle 30 starts to transfer the transfer object 90 or at an arbitrary time during transfer of the transfer object 90. Note that some of the steps may be carried out in parallel or in a changed order.

### (Step S201)

In step S201, the control unit 32 acquires information that is detected by the sensor 33 during transfer of the transfer object 90, that is, sensor information that indicates the distance d between the transfer object 90 and the transfer vehicle 30. The control unit 32 transmits, to the management apparatus 40, the sensor information thus acquired.

### (Step S202)

In step S202, the control unit 42 stores, in the storage unit 43, the sensor information which has been received from the transfer vehicle 30. In the storage unit 43, the sensor information generated at a plurality of times, i.e., time-series data of the sensor information is stored.

### (Step S203)

In step S203, the estimation unit 422 extracts a feature from the time-series data of the sensor information that is stored in the storage unit 43. In one example, the estimation unit 422 extracts a variation pattern of the distance on the basis of the time-series data of the sensor information stored in the storage unit 43. The variation pattern includes, for example, (i) an analysis result obtained by difference conversion of the time-series data and/or (ii) an analysis result in a frequency domain of the time-series data.

In a case where the estimation unit 422 extracts the variation pattern by a difference conversion process, the variation pattern extracted tends to exhibit a characteristic of variation in a period from the start of transfer by the transfer vehicle 30 (that is, the start of movement of the transfer vehicle 30) until elapse of a predetermined period. Further, in a case where the estimation unit 422 extracts the variation pattern by a frequency domain analysis, the variation pattern extracted tends to exhibit a characteristic of variation in a period in which the movement speed of the transfer vehicle 30 is stable (for example, a period after elapse of the predetermined period from the start of the movement). Note that a method by which the estimation unit 422 extracts the variation pattern of the time-series data is not limited to those described above, and the estimation unit 422 may extract the variation pattern by another method.

### (Steps S204 and S205)

In step S204, the estimation unit 422 inputs the feature extracted in step S203 to the estimation model 433. In step S205, the estimation unit 422 estimates the weight of the transfer object 90 on the basis of an output result which is obtained by inputting the feature to the estimation model 433 in step S204. The estimation unit 422 transmits, to the transfer vehicle 30, information that indicates the weight estimated.

### (Step S206)

In step S206, the weight output unit 322 displays, on the display 34 on the basis of the information received from the management apparatus 40, the weight which has been estimated by the management apparatus 40. A user such as a manager of the transfer vehicle 30 can ascertain the weight of the transfer object 90 by checking the weight that is displayed on the display 34. Further, for example, in a case where the weight estimated deviates, to a large extent, from an expected value, a user can find the possibility that, for example, the content of the transfer object 90 is not an intended content.

### (Step S207)

In step S207, the transfer control unit 421 determines a parameter on the basis of the weight estimated in step S205 and stores, in the storage unit 43, the parameter thus determined. In one example, the transfer control unit 421 may determine the parameter such that the larger the weight estimated becomes, the larger the force applied to the transfer object 90 by the transfer vehicle 30 becomes. Further, in one example, when the transfer vehicle 30 travels along a curve, the transfer control unit 421 may determine the parameter such that the larger the weight is, the smaller the travel speed becomes. Further, in one example, when the transfer vehicle comes close to an end point (destination) of transfer, the transfer control unit 421 may determine the parameter such that the larger the weight is, the earlier the time to start deceleration becomes.

### (Steps S208 and S209)

In step S208, the transfer control unit 421 transmits, to the transfer vehicle 30, control information on the basis of the parameter that has been determined in step S207. In step S209, the control unit 32 controls drive of the power motor in accordance with the control information that has been received from the management apparatus 40, and transfers the transfer object 90. In other words, the transfer control unit 421 controls the transfer vehicle 30 with use of the parameter in accordance with the weight estimated by the estimation unit 422.

As described above, in the transfer system 2 according to the present example embodiment, the management apparatus 40 extracts a variation pattern of the distance between the transfer object 90 and the transfer vehicle 30, on the basis of time-series data of sensor information that indicates the distance. Then, the management apparatus 40 estimates the weight on the basis of the variation pattern extracted. According to the present example embodiment, this allows for estimation of the weight of the transfer object in a wider variety of transfer embodiments.

Further, since the management apparatus 40 can estimate the weight of the transfer object 90 during transfer of the transfer object 90, there is no need to carry out, separately from a transfer operation, a work or the like for measuring the weight of the transfer object 90.

Further, the management apparatus 40 estimates the weight with use of the time-series data from the start of transfer by the transfer vehicle 30 until elapse of a predetermined period from the start of the transfer. As illustrated in FIG. 12, an effect of the weight greatly appears on the characteristic of the time-series data in a period from when the transfer vehicle 30 starts transferring until the movement speed is stabilized (a period in which acceleration is carried out). Therefore, with use of the time-series data of a period of starting movement of the transfer vehicle 30, the weight can be more accurately estimated.

### Third Example Embodiment

The following description will discuss a third example embodiment of the present invention, with reference to the drawings. Note that members having functions identical to those of the respective members described in the first example embodiment or the second example embodiment are given respective identical reference numerals, and descriptions of those members will be omitted as appropriate.

### Transfer Embodiment of Transfer System

FIG. 14 is a diagram schematically illustrating a transfer embodiment of a transfer system 3 in accordance with the third example embodiment. In FIG. 14, a first transfer vehicle 30A and a second transfer vehicle 30B carry out, in cooperation with each other, cooperative transfer of a transfer object 90 in a direction of an arrow D. The cooperative transfer refers to transferring a transfer object bundle by a plurality of transfer vehicles in cooperation with each other. The transfer object bundle is a transfer object, for example, in a state in which one or more transfer objects are contained in a lattice-shaped structure (basket), a state in which a plurality of transfer objects are contained in a box, or a state in which two or more transfer objects are fixed by a tape or the like. Note that in the following description, the first transfer vehicle 30A is disposed behind the transfer object 90 in a transfer direction of the transfer object 90, and the second transfer vehicle 30B is disposed ahead of the transfer object 90 in the transfer direction. The first transfer vehicle 30A and the second transfer vehicle 30B sandwich the transfer object 90 and move at respective speeds that are the same or substantially the same each other, so that the transfer object 90 is transferred. The first transfer vehicle 30A and the second transfer vehicle 30B are not coupled to each other. A distance between the first transfer vehicle 30A and the second transfer vehicle 30B is not fixed. Therefore, the transfer system 3 can transfer the transfer object 90 of any of various sizes while sandwiching the transfer object 90 between the first transfer vehicle 30A and the second transfer vehicle 30B. However, a method of the cooperative transfer is not limited to the above. For example, a plurality of transfer vehicles may transfer a transfer object while sandwiching the transfer object in a direction perpendicular to the transfer direction, or three or more transfer vehicles may carry out cooperative transfer by pushing the transfer object from respective directions.

The first transfer vehicle 30A includes a coupling part 301A, and the second transfer vehicle 30B includes a coupling part 301B. The coupling part 301A and the coupling part 301B have the same configuration as the coupling part 301 in accordance with the second example embodiment described above. The first transfer vehicle 30A and the second transfer vehicle 30B move at respective speeds that are the same or substantially the same each other, but an error occurs in these movement speeds due to an influence of external force or the like. The coupling part 301A and the coupling part 301B also function to absorb such an error. The first transfer vehicle 30A and the second transfer vehicle 30B sandwich the transfer object 90 therebetween and transfer the transfer object 90, so that the transfer object 90 moves while oscillating between the first transfer vehicle 30A and the second transfer vehicle 30B.

More specifically, the first transfer vehicle 30A moves in the direction of the arrow D. As a result, force is applied to the transfer object 90 by the first transfer vehicle 30A via the coupling part 301A, and the transfer object 90 moves in the direction of the arrow D. Since the coupling parts 301A and 301B each include an elastic body, a distance d1 between the first transfer vehicle 30A and the transfer object 90 and a distance d2 between the second transfer vehicle 30B and the transfer object 90 vary with time during transfer of the transfer object 90. The distance d1 and the distance d2 vary, to a larger extent, particularly over a period from when the transfer object 90 starts to move until when the speed stabilizes. Specifically, when pushing force is applied to the transfer object 90 by the first transfer vehicle 30A (or the second transfer vehicle 30B), the distance d1 (or the distance d2) decreases. On the other hand, when no force is applied to the transfer object 90 by the first transfer vehicle 30A (or the second transfer vehicle 30B), the distance d1 (or the distance d2) becomes large.

### <Configuration of Transfer System>

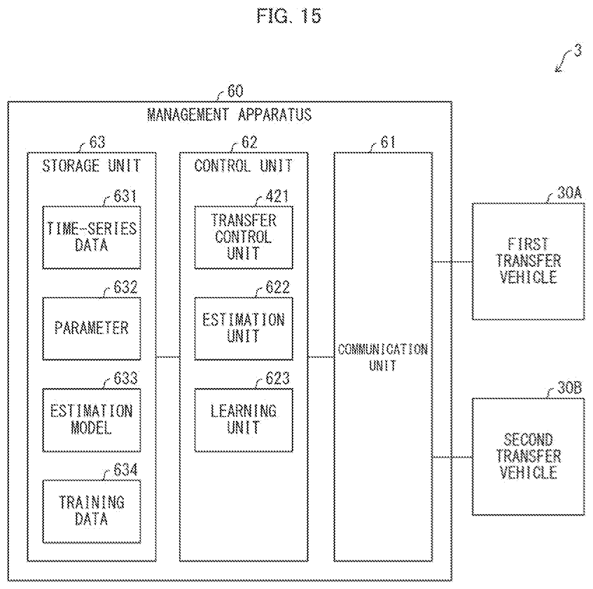

FIG. 15 is a block diagram illustrating a configuration of the transfer system 3. The transfer system 3 includes the first transfer vehicle 30A, the second transfer vehicle 30B, and a management apparatus 60. The first transfer vehicle 30A and the second transfer vehicle 30B are each configured in the same manner as the transfer vehicle 30 in accordance with the second example embodiment described above.

The management apparatus 60 includes a communication unit 61, a control unit 62, and a storage unit 63. The communication unit 61 transmits and receives information to and from the first transfer vehicle 30A and the second transfer vehicle 30B via a communication line, under control of the control unit 62. Hereinafter, transmitting and receiving information by the control unit 62 to and from the first transfer vehicle 30A and the second transfer vehicle 30B via the communication unit 61 is also described simply as transmitting and receiving information by the control unit 62 to and from the first transfer vehicle 30A and the second transfer vehicle 30B.

The control unit 62 includes a transfer control unit 421, an estimation unit 622, and a learning unit 623. The estimation unit 622 estimates, with use of an estimation model 633, the weight of the transfer object 90 by using time-series data of sensor information outputted by the first transfer vehicle 30A and/or time-series data of sensor information outputted by the second transfer vehicle 30B. In the following description, the time-series data of the sensor information outputted by the first transfer vehicle 30A is also referred to as “first time-series data”. Further, the time-series data of the sensor information outputted by the second transfer vehicle 30B is also referred to as “second time-series data”.

The estimation model 633 is a trained model which has undergone machine learning so as to output the weight of the transfer object 90 by using, as an input, the time-series data or a feature of the time-series data. A method of machine learning of the estimation model 633 is, for example, a decision tree-based method, a method using linear regression, or a method using a neural network. It is also possible to use two or more of these methods.

The input to the estimation model 633 include, for example, (i) a feature of the first time-series data and/or (ii) a feature of the second time-series data. Further, the input of the estimation model 633 may also include an oscillation pattern of oscillation of the transfer object 90 between the first transfer vehicle 30A and the second transfer vehicle 30B. The oscillation pattern is identified on the basis of the first time-series data and/or the second time-series data. In the present specification, among variations, those having a periodicity or semi-periodicity is also referred to as an oscillation.

The learning unit 623 generates the estimation model 633 by machine learning with use of training data 634. The training data 634 is, for example, a set of first data and second data. The first data indicates the feature of the time-series data of the sensor information at the time when the first transfer vehicle 30A and the second transfer vehicle 30B actually transfer the transfer object 90. The second data indicates the weight of the transfer object 90. The first data includes, for example, (i) the feature of the first time-series data and/or (ii) the feature of the second time-series data. Further, the first data may also include an oscillation pattern of oscillation of the transfer object 90 between the first transfer vehicle 30A and the second transfer vehicle 30B. The oscillation pattern is identified on the basis of the first time-series data and/or the second time-series data.

The storage unit 63 stores the time-series data 631, a parameter 632, the estimation model 633, and the training data 634. The time-series data 631 includes the first time-series data and/or the second time-series data. The parameter 632 includes a control parameter for controlling transfer carried out by the first transfer vehicle 30A and a control parameter for controlling transfer carried out by the second transfer vehicle 30B. In one example, the parameter 632 includes, for example, a parameter(s) that relates to (i) a target value of the distance d1, (ii) a target value of the distance d2, (iii) the movement speed of the first transfer vehicle 30A, (iv) the movement speed of the second transfer vehicle 30B, (v) acceleration/deceleration of the transfer vehicle 30A, (vi) acceleration/deceleration of the second transfer vehicle 30B, (vii) deceleration/stop timing of the first transfer vehicle 30A, (viii) deceleration/stop timing of the second transfer vehicle 30B, and/or (ix) cooperative control of cooperative transfer carried out by the first transfer vehicle 30A and the second transfer vehicle 30B. More specifically, examples of the parameter 432 include maximum travel speeds, a restriction on acceleration/deceleration (steepness), a distance to a goal or obstacle at which deceleration is to be started, and/or a gain factor in cooperative control of the first transfer vehicle 30A and the second transfer vehicle 30B.

### <Flow of Transfer Method>

In starting transfer of the transfer object 90, the first transfer vehicle 30A and the second transfer vehicle 30B apply force to the transfer object 90 under control of the management apparatus 60 so as to sandwich the transfer object 90. When the force is applied to the transfer object 90, the distance d1 and the distance d2 become smaller than those in a case in which no force is applied to the transfer object 90. The management apparatus 60 carries out control as follows: start moving the first transfer vehicle 30A and the second transfer vehicle 30B at respective speeds that are the same or substantially the same each other in a state in which the distance d1 and the distance d2 are reduced; and gradually reduce the force applied to the transfer object 90 as time elapses after the start of the movement. Note that the method of the transfer control carried out by the management apparatus 60 is not limited to the above-described control, and the transfer control may be carried out by another method.

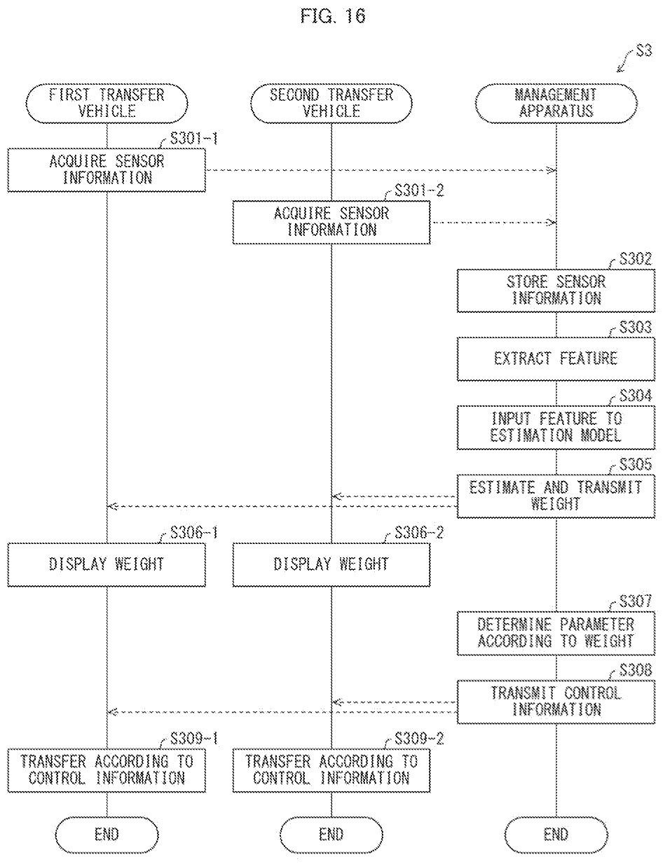

FIG. 16 is a flow chart illustrating a flow of a transfer method S3 according to the present example embodiment. The transfer method S3 is started at the time when the first transfer vehicle 30A and the second transfer vehicle 30B start to transfer the transfer object 90 or at an arbitrary time during transfer of the transfer object 90. Note that some of steps may be carried out in parallel or in a changed order.

In step S301-1, the acquisition unit 321 of the first transfer vehicle 30A acquires first sensor information that changes in accordance with the distance d1 between the transfer object 90 and the first transfer vehicle 30A. Further, in step S301-2, the acquisition unit 321 of the second transfer vehicle 30B acquires second sensor information that changes in accordance with the distance d2 between the transfer object 90 and the second transfer vehicle 30B. In other words, the acquisition unit 321 acquires sensor information which includes the first sensor information that changes in accordance with the distance d1 between the transfer object 90 and the first transfer vehicle 30A and/or the second sensor information that changes in accordance with the distance d2 between the transfer object 90 and the second transfer vehicle 30B.

In step S302, the control unit 62 stores, in the storage unit 63, the sensor information which has been received from the first transfer vehicle 30A and the sensor information which has been received from the second transfer vehicle 30B. The storage unit 63 stores the first time-series data of the sensor information which has been received from the first transfer vehicle 30A and the second time-series data of the sensor information which has been received from the second transfer vehicle 30B.

In steps S303 to S305, the estimation unit 622 estimates the weight of the transfer object 90 with use of (i) the first time-series data and/or the second time-series data and (ii) the estimation model 633. In one example, the estimation unit 622 estimates the weight on the basis of the output result which is obtained by inputting, to the estimation model 633, the feature of the first time-series data and/or the feature of the second time-series data. Further, in one example, the estimation unit 622 extracts an oscillation pattern of oscillation of the transfer object 90 between the first transfer vehicle 30A and the second transfer vehicle 30B, on the basis of the time-series data of the sensor information, and estimates the weight on the basis of the oscillation pattern thus extracted. Furthermore, in step S305, the estimation unit 622 transmits, to the first transfer vehicle 30A and the second transfer vehicle 30B, information that indicates the weight estimated.

In step S306-1, the weight output unit 322 of the first transfer vehicle 30A displays, on the display 34 on the basis of the information received from the management apparatus 40, the weight which has been estimated by the management apparatus 40. Further, in step S306-2, the weight output unit 322 of the second transfer vehicle 30B displays, on the display 34 on the basis of the information received from the management apparatus 40, the weight which has been estimated by the management apparatus 40. Note that it is not necessary that both of the first transfer vehicle 30A and the second transfer vehicle 30B display the weight and only the first transfer vehicle 30A or the second transfer vehicle 30B may display the weight.

In step S307, the transfer control unit 421 determines, in accordance with the weight estimated, a parameter for controlling transfer carried out by the first transfer vehicle 30A and a parameter for controlling transfer carried out by the second transfer vehicle 30B. In one example, the transfer control unit 421 may determine the parameter such that the larger the weight estimated is, the higher a follow-up speed of the first transfer vehicle 30A becomes. Further, for example, the transfer control unit 421 may determine the parameter such that the larger the weight estimated is, the more the second transfer vehicle 30B is decelerated. Further, for example, when the first transfer vehicle 30A and the second transfer vehicle 30B travel on a curve, the transfer control unit 421 may determine the parameter such that the larger the weight is, the lower the travel speed becomes. Further, when the first transfer vehicle 30A and the second transfer vehicle 30B come close to an end point (destination) of transfer, the transfer control unit 421 may determine the parameter such that the larger the weight is, the earlier the time to start deceleration becomes.

In step S308, the transfer control unit 421 transmits, to the first transfer vehicle 30A and the second transfer vehicle 30B, the control information on the basis of the parameter which has been determined in step S307. In steps S309-1 and S309-2, the control unit 32 of the first transfer vehicle 30A and the control unit 32 of the second transfer vehicle 30B carry out cooperative transfer of the transfer object 90, by controlling drive of the power motor in accordance with the control information which has been received from the management apparatus 40.

As described above, in the transfer system 3 according to the present example embodiment, the first transfer vehicle 30A and the second transfer vehicle 30B carry out cooperative transfer of the transfer object 90. The management apparatus 60 estimates the weight on the basis of the first time-series data of the sensor information of the first transfer vehicle 30A and the second time-series data of the sensor information of the second transfer vehicle 30B. Thus, according to the present example embodiment, it is possible to estimate the weight during transfer of a transfer object in cooperative transfer using a plurality of transfer vehicles.

### Software Implementation Example

Part or all of functions of the transfer vehicle 10, 30, the first transfer vehicle 10A, 30A, the second transfer vehicle 10B, 30A, and the management apparatus 20, 40, 60 (hereinafter, referred to as “management apparatus 20 and/or the like”) can be realized by hardware such as an integrated circuit (IC chip) or the like or can be alternatively realized by software.

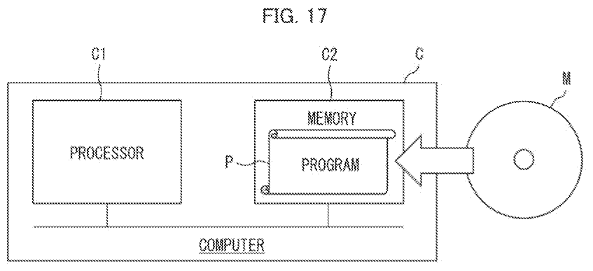

In the latter case, the management apparatus 20 and/or the like is realized by, for example, a computer that executes instructions of a program that is software realizing the foregoing functions. FIG. 17 illustrates an example of such a computer (hereinafter referred to as “computer C”). The computer C includes at least one processor C1 and at least one memory C2. In the memory C2, a program P for causing the computer C to operate as the management apparatus 20 and/or the like is stored. In the computer C, the foregoing functions of the management apparatus 20 and/or the like can be realized by the processor C1 reading and executing the program P stored in the memory C2.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a microcontroller or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. In addition, the computer C may further include an input/output interface such as a keyboard, a mouse, a display, and/or a printer.

The program P can also be stored in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

### [Additional Remark 1]

In the above-described second or third example embodiment, the estimation unit 422 or 622 (hereinafter, referred to as “estimation unit 422 or the like”) estimates the weight of the transfer object 90 on the basis of time-series data of the distance detected by the sensor 33 as the time-series data of the sensor information. The time-series data of the sensor information is not limited to the time-series data of the distance, and the time-series data may be other data. The time-series data of the sensor information may be, for example, time-series data of a stress applied to the transfer object 90. That is, the estimation unit 422 or the like may convert the time-series data into time-series data of the stress applied to the transfer object in accordance with the distance, and estimate the weight on the basis of the time-series data after conversion. Depending on the type of the elastic body included in the coupling part 301 or the like, there is a case where the relationship between the weight and the distance is not linear, and an error may occur in an estimation result of the weight. The estimation unit 422 or the like calculates the stress on the basis of the distance measured by the sensor 33 and estimates the weight on the basis of time-series data of the stress calculated. This makes it possible to more accurately estimate the weight.

### [Additional Remark 2]

In the above-described second or third example embodiment, in a case where the caster 303 is not oriented in a positive direction, a resistance force is generated when the direction of the caster 303 is changed. In some cases, the weight cannot be accurately estimated due to an effect of this resistance force. In light of the above, in a case where the caster 303 is not oriented in the positive direction, the estimation unit 422 or the like may estimate the weight not on the basis of time-series data that is obtained immediately after transfer of the transfer object 90 is started but on the basis of time-series data that is obtained after the transfer of the transfer object 90 is carried out for a while and the caster 303 is oriented in the positive direction.

In this case, the estimation unit 422 or the like may estimate the weight on the basis of the time-series data that is obtained after a second condition is satisfied subsequent to the start of the transfer of the transfer object 90 by the transfer vehicle 30 or the like. In one example, the second condition includes the following condition: a predetermined period has elapsed; or the transfer vehicle 90 travels by a predetermined distance in the positive direction. In one example, the moving distance of the transfer vehicle 30 may be calculated by (i) analyzing an image captured by a camera configured to capture an image of the transfer vehicle 30 or the like and (ii) detecting the position of the transfer vehicle 30. Alternatively, the second condition may be a condition that the caster 303 is detected to be oriented in the positive direction by a sensor that detects an orientation of the caster 303. The sensor that detects the orientation of the caster 303 is, for example, a camera that captures an image of the transfer vehicle 30 or the like. In a case where the estimation unit 422 or the like estimates the weight on the basis of the time-series data that is obtained after the second condition is satisfied, it is possible to more accurately estimate the weight.

### [Additional Remark 3]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 4]

The whole or part of the example embodiments disclosed above can also be described as below. Note, however, that the present invention is not limited to the following example aspects.

### (Supplementary Note 1)

A transfer system including:
an acquisition means for acquiring sensor information that changes in accordance with a distance between a transfer object and a transfer vehicle that is transferring the transfer object; and
an estimation means for estimating a weight of the transfer object on the basis of time-series data of the sensor information.

The above configuration makes it possible to estimate the weight of the transfer object in a wider variety of transfer embodiments.

### (Supplementary Note 2)

The transfer system according to supplementary note 1, wherein
the estimation means extracts a variation pattern of the distance on the basis of the time-series data of the sensor information and estimates the weight on the basis of the variation pattern thus extracted.

The above configuration makes it possible to estimate the weight of the transfer object in a wider variety of transfer embodiments.

### (Supplementary Note 3)

The transfer system according to supplementary note 1 or 2, wherein
the estimation means estimates the weight on the basis of the time-series data which is obtained in a period from when the transfer vehicle starts to transfer the transfer object until when a first condition is satisfied.

The above configuration allows the transfer system to more accurately estimate the weight by estimating the weight on the basis of the time-series data in which an effect of the weight greatly appears on a characteristic of the time-series data.

### (Supplementary Note 4)

The transfer system according to any one of supplementary notes 1 to 3, wherein
the transfer vehicle includes a first transfer vehicle and a second transfer vehicle that transfers the transfer object in cooperation with the first transfer vehicle.

The above configuration makes it possible to estimate the weight during transfer of the transfer object in the transfer system which carries out cooperative transfer using a plurality of transfer vehicles.

### (Supplementary Note 5)

The transfer system according to supplementary note 4, wherein
the estimation means extracts an oscillation pattern of oscillation of the transfer object between the first transfer vehicle and the second transfer vehicle, on the basis of the time-series data of the sensor information, and estimates the weight on the basis of the oscillation pattern thus extracted.

The above configuration makes it possible to more accurately estimate the weight of the transfer object in the transfer system which carries out cooperative transfer using a plurality of transfer vehicles.

### (Supplementary Note 6)

The transfer system according to any one of supplementary notes 1 to 5, wherein
the estimation means estimates the weight with use of an estimation model which has been generated by machine learning and which outputs the weight by using the time-series data of the sensor information as an input.

In the above configuration, the transfer system estimates the weight by inputting the time-series data to the estimation model. This makes it possible to more accurately estimate the weight.

### (Supplementary Note 7)

A transfer apparatus including:
an acquisition means for acquiring sensor information that changes in accordance with a distance between a transfer object and a transfer vehicle that is transferring the transfer object; and
an estimation means for estimating a weight of the transfer object on the basis of time-series data of the sensor information.

The above configuration makes it possible to estimate the weight of the transfer object in a wider variety of transfer embodiments.

### (Supplementary Note 8)

The transfer apparatus according to supplementary note 7, wherein
the estimation means extracts a variation pattern of the distance on the basis of the time-series data of the sensor information and estimates the weight on the basis of the variation pattern thus extracted.

The above configuration makes it possible to estimate the weight of the transfer object in a wider variety of transfer embodiments.

### (Supplementary Note 9)

The transfer apparatus according to supplementary note 7 or 8, wherein
the estimation means estimates the weight on the basis of the time-series data which is obtained in a period from when the transfer vehicle starts to transfer the transfer object until when a first condition is satisfied.

The above configuration allows the transfer apparatus to more accurately estimate the weight by estimating the weight on the basis of the time-series data in which an effect of the weight greatly appears on a characteristic of the time-series data.

### (Supplementary Note 10)

The transfer apparatus according to any one of supplementary notes 7 to 9, wherein
the transfer vehicle includes a first transfer vehicle and a second transfer vehicle that transfers the transfer object in cooperation with the first transfer vehicle.

The above configuration makes it possible to estimate the weight during transfer by cooperative transfer using a plurality of transfer vehicles.

### (Supplementary Note 11)

The transfer apparatus according to supplementary note 10, wherein
the estimation means extracts an oscillation pattern of oscillation of the transfer object between the first transfer vehicle and the second transfer vehicle, on the basis of the time-series data of the sensor information, and estimates the weight on the basis of the oscillation pattern thus extracted.

The above configuration makes it possible to more accurately estimate the weight during transfer by cooperative transfer using a plurality of transfer vehicles.

### (Supplementary Note 12)

The transfer apparatus according to any one of supplementary notes 7 to 11, wherein
the estimation means estimates the weight with use of an estimation model which has been generated by machine learning and which outputs the weight by using the time-series data of the sensor information as an input.

In the above configuration, the transfer apparatus estimates the weight by inputting the time-series data to the estimation model. This makes it possible to more accurately estimate the weight.

### (Supplementary Note 13)

A transfer method including:
an acquisition means for acquiring sensor information that changes in accordance with a distance between a transfer object and a transfer vehicle that is transferring the transfer object; and
an estimation means for estimating a weight of the transfer object on the basis of time-series data of the sensor information.

The above configuration makes it possible to estimate the weight of the transfer object in a wider variety of transfer embodiments.

### (Supplementary Note 14)

The transfer method according to supplementary note 13, wherein
in estimating the weight of the transfer object, a variation pattern of the distance is extracted on the basis of the time-series data of the sensor information and the weight is estimated on the basis of the variation pattern thus extracted.

The above configuration makes it possible to estimate the weight of the transfer object in a wider variety of transfer embodiments.

### (Supplementary Note 15)

The transfer method according to supplementary note 13 or 14, wherein
in estimating the weight of the transfer object, the weight is estimated on the basis of the time-series data which is obtained in a period from when the transfer vehicle starts to transfer the transfer object until when a first condition is satisfied.

The above configuration makes it possible to more accurately estimate the weight by estimating the weight on the basis of the time-series data in which an effect of the weight greatly appears on a characteristic of the time-series data.

### (Supplementary Note 16)

The transfer method according to any one of supplementary notes 13 to 15, wherein
the transfer vehicle includes a first transfer vehicle and a second transfer vehicle that transfers the transfer object in cooperation with the first transfer vehicle.

The above configuration makes it possible to estimate the weight during transfer by cooperative transfer using a plurality of transfer vehicles.

### (Supplementary Note 17)

The transfer method according to supplementary note 16, wherein
in estimating the weight of the transfer vehicle, an oscillation pattern of oscillation of the transfer object between the first transfer vehicle and the second transfer vehicle is extracted on the basis of the time-series data of the sensor information and the weight is estimated on the basis of the oscillation pattern thus extracted.

The above configuration makes it possible to more accurately estimate the weight of the transfer object in cooperative transfer using a plurality of transfer vehicles.

### (Supplementary Note 18)

The transfer methods according to any one of supplementary notes 13 to 17, wherein
in estimating the weight of the transfer object, the weight is estimated with use of an estimation model which has been generated by machine learning and which outputs the weight by using the time-series data of the sensor information as an input.

In the above configuration, the weight is estimated by inputting the time-series data to the estimation model. This makes it possible to more accurately estimate the weight.

### (Supplementary Note 19)

The transfer system according to supplementary note 6, further including
a learning means that generates the estimation model by machine learning.

### (Supplementary Note 20)

The transfer system according to supplementary note 4, wherein
the acquisition means acquires the sensor information which includes first sensor information that changes in accordance with a distance between the transfer object and the first transfer vehicle and/or second sensor information that changes in accordance with a distance between the transfer object and the second transfer vehicle.

### (Supplementary Note 21)

The transfer system according to supplementary note 2, wherein
the estimation means extracts, as the variation pattern, (i) an analysis result obtained by difference conversion of the time-series data and/or (ii) an analysis result in a frequency domain of the time-series data.

### (Supplementary Note 22)

The transfer system according to any one of supplementary notes 1 to 6 and 19 to 21, wherein
the estimation means estimates the weight on the basis of the time-series data which is obtained after a second condition is satisfied subsequent to the start of transfer of the transfer object by the transfer vehicle.

### (Supplementary Note 23)

The transfer system according to any one of supplementary notes 1 to 6 and 19 to 22, wherein
the estimation means converts the time-series data into converted time-series data of a stress that is applied to the transfer object in accordance with the distance, and estimates the weight on the basis of the converted time-series data.

### (Supplementary Note 24)

The transfer system according to any one of supplementary notes 1 to 6 and 19 to 23, further including
a transfer control means that controls the transfer vehicle, with use of a parameter in accordance with the weight estimated by the estimation means.

### (Supplementary Note 25)

The transfer system according to any one of supplementary notes 1 to 6 and 19 to 24, further including
a weight output means that outputs, to an output apparatus, the weight estimated by the estimation means.

### (Supplementary Note 26)

The transfer system according to any one of supplementary notes 1 to 6 and 19 to 25, including
one or more of the transfer vehicles and a management apparatus,
the transfer vehicles each including at least the acquisition means; and
the management apparatus including at least the estimation means.

### (Supplementary Note 27)

A program for causing a computer to function as a transfer apparatus,
the program causing the computer to function as:
an acquisition means for acquiring sensor information that changes in accordance with a distance between a transfer object and a transfer vehicle that is transferring the transfer object; and
an estimation means for estimating a weight of the transfer object on the basis of time-series data of the sensor information.

### (Supplementary Note 28)

The program according to supplementary note 27, wherein
the estimation means extracts a variation pattern of the distance on the basis of the time-series data of the sensor information and estimates the weight on the basis of the variation pattern thus extracted.

### (Supplementary Note 29)

The program according to supplementary note 27 or 28, wherein
the estimation means estimates the weight on the basis of the time-series data which is obtained in a period from when the transfer vehicle starts to transfer the transfer object until when a first condition is satisfied.

### (Supplementary Note 30)

The program according to any one of supplementary notes 27 to 29, wherein
the transfer vehicle includes a first transfer vehicle and a second transfer vehicle that transfers the transfer object in cooperation with the first transfer vehicle.

### (Supplementary Note 31)

The program according to supplementary note 30, wherein
the estimation means extracts an oscillation pattern of oscillation of the transfer object between the first transfer vehicle and the second transfer vehicle, on the basis of the time-series data of the sensor information, and estimates the weight on the basis of the oscillation pattern thus extracted.

### (Supplementary Note 32)

The program according to any one of supplementary notes 27 to 31, wherein
the estimation means estimates the weight with use of an estimation model which has been generated by machine learning and which outputs the weight by using the time-series data of the sensor information as an input.

### [Additional Remark 5]

Some of or all of the foregoing example embodiments can further be expressed as below.

A transfer apparatus including at least one processor, the processor carrying out:
an acquisition process for acquiring sensor information that changes in accordance with a distance between a transfer object and a transfer vehicle that is transferring the transfer object; and
an estimation process for estimating a weight of the transfer object on the basis of time-series data of the sensor information.

Note that the transfer apparatus can further include a memory. The memory can store a program for causing the processor to carry out the acquisition process and the estimation process. In addition, the program may be stored in a computer-readable non-transitory tangible storage medium.

### REFERENCE SIGNS LIST

1, 2, 3 transfer system
10, 30 transfer vehicle
10A, 30A first transfer vehicle
10B, 30A second transfer vehicle
11, 321: acquisition unit
12, 422, 622 estimation unit
13, 21, 31, 41, 61 communication unit
20, 40, 60 management apparatus
32, 42, 62 control unit
33 sensor
34 display
motor driver
36 power motor
43, 63 storage unit
90 transfer object
101, 101A, 101B, 301, 301A, 301B coupling part
302 wheel
303 caster
304 main body part
305 rotating part
306 rotation shaft
322 weight output unit
323 drive control unit
421 transfer control unit
423, 623 learning unit

What is claimed is:

1. A transfer system comprising at least one processor,
the at least one processor carrying out:
an acquisition process for acquiring sensor information that changes in accordance with a distance between a transfer object and a transfer vehicle that is transferring the transfer object; and
an estimation process for estimating a weight of the transfer object on the basis of time-series data of the sensor information.

2. The transfer system according to claim 1, wherein
in the estimation process, the at least one processor extracts a variation pattern of the distance on the basis of the time-series data of the sensor information and estimates the weight on the basis of the variation pattern thus extracted.

3. The transfer system according to claim 1, wherein
in the estimation process, the at least one processor estimates the weight on the basis of the time-series data which is obtained in a period from when the transfer vehicle starts to transfer the transfer object until when a first condition is satisfied.

4. The transfer system according to claim 1, wherein
the transfer vehicle includes a first transfer vehicle and a second transfer vehicle that transfers the transfer object in cooperation with the first transfer vehicle.

5. The transfer system according to claim 4, wherein
in the estimation process, the at least one processor extracts an oscillation pattern of oscillation of the transfer object between the first transfer vehicle and the second transfer vehicle, on the basis of the time-series data of the sensor information, and estimates the weight on the basis of the oscillation pattern thus extracted.

6. The transfer system according to claim 1, wherein
in the estimation process, the at least one processor estimates the weight with use of an estimation model which has been generated by machine learning and which outputs the weight by using the time-series data of the sensor information as an input.

7. A transfer apparatus comprising at least one processor,
the at least one processor carrying out:
an acquisition process for acquiring sensor information that changes in accordance with a distance between a transfer object and a transfer vehicle that is transferring the transfer object; and
an estimation process for estimating a weight of the transfer object on the basis of time-series data of the sensor information.

8. The transfer apparatus according to claim 7, wherein
in the estimation process, the at least one processor extracts a variation pattern of the distance on the basis of the time-series data of the sensor information and estimates the weight on the basis of the variation pattern thus extracted.

9. The transfer apparatus according to claim 7, wherein
in the estimation process, the at least one processor estimates the weight on the basis of the time-series data which is obtained in a period from when the transfer vehicle starts to transfer the transfer object until when a first condition is satisfied.

10. The transfer apparatus according to claim 7, wherein
the transfer vehicle includes a first transfer vehicle and a second transfer vehicle that transfers the transfer object in cooperation with the first transfer vehicle.

11. The transfer apparatus according to claim 10, wherein
in the estimation process, the at least one processor extracts an oscillation pattern of oscillation of the transfer object between the first transfer vehicle and the second transfer vehicle, on the basis of the time-series data of the sensor information, and estimates the weight on the basis of the oscillation pattern thus extracted.

12. The transfer apparatus according to claim 7, wherein
in the estimation process, the at least one processor estimates the weight with use of an estimation model which has been generated by machine learning and which outputs the weight by using the time-series data of the sensor information as an input.

13. A transfer method comprising:
acquiring sensor information that changes in accordance with a distance between a transfer object and a transfer vehicle that is transferring the transfer object; and
estimating a weight of the transfer object on the basis of time-series data of the sensor information.

14. The transfer method according to claim 13, wherein
in estimating the weight of the transfer object, a variation pattern of the distance is extracted on the basis of the time-series data of the sensor information and the weight is estimated on the basis of the variation pattern thus extracted.

15. The transfer method according to claim 13, wherein
in estimating the weight of the transfer object, the weight is estimated on the basis of the time-series data which is obtained in a period from when the transfer vehicle starts to transfer the transfer object until when a first condition is satisfied.

16. The transfer method according to claim 13, wherein
the transfer vehicle includes a first transfer vehicle and a second transfer vehicle that transfers the transfer object in cooperation with the first transfer vehicle.

17. The transfer method according to claim 16, wherein
in estimating the weight of the transfer vehicle, an oscillation pattern of oscillation of the transfer object between the first transfer vehicle and the second transfer vehicle is extracted on the basis of the time-series data of the sensor information and the weight is estimated on the basis of the oscillation pattern thus extracted.

18. The transfer methods according to claim 13, wherein
in estimating the weight of the transfer object, the weight is estimated with use of an estimation model which has been generated by machine learning and which outputs the weight by using the time-series data of the sensor information as an input.

19. A computer-readable non-transitory storage medium storing a program for causing a computer to function as a transfer device according to claim 7, the program for causing the computer to carry out the acquisition process and the estimation process.
